(19) United States
(12) Patent Application Publication
(10) Pub. No.: US 2012/0139547 A1
(43) Pub. Date: Jun. 7, 2012

(54) Systems and Methods of Cell Imbalance Detection

(75) Inventors: Allen Y. Chen, Austin, TX (US); Richard Nicholson, Aptos, CA (US)

(73) Assignee: Texas Instruments Incorporated, Dallas, TX (US)

(21) Appl. No.: 12/961,450

(22) Filed: Dec. 6, 2010

(51) Int. Cl. G01N 27/416

(52) U.S. Cl. 324/433; 324/434

(57) ABSTRACT

Example embodiments of the systems and methods of cell imbalance detection disclosed herein may prevent any cell of a multi-cell battery pack from exceeding over voltage conditions of the battery. In an example embodiment, automatic cell imbalance detection may be performed using two cells in series. The example embodiment determines the relative cell voltages. If a difference between the two cells of more than a certain threshold is detected, a cell balancing circuit may be activated to discharge the cell with the higher voltage. Example embodiments use no microprocessor, nor an ADC. An advantage of this approach over previous solutions is the relative knowledge of the cell voltages.

### TECHNICAL FIELD

The present disclosure is generally related to electronics and, more particularly, is related to battery packs.

### BACKGROUND

Different algorithms of cell balancing are often discussed when multiple serial cells are used in a battery pack for particular device. Means used to perform cell balancing may include by-passing some of the cells during charge and sometimes during discharge, for example. Typical by-pass currents range from a few milliamps to amperes. Difference of cell voltages is a most typical manifestation of unbalance, which is attempted to be corrected either instantaneously or gradually through by-passing cells with higher voltage. State of charge unbalance is caused by cells being charged to different state of charge (SOC) levels. For example, three 2200 mAh cells (Qmax) are discharged at different rates: one by 100 mAh (Q1), a second by 100 mAh and a third by 200 mAh from a fully charged state, the first and second cells chemical state of charge will be (Qmax−Q1)/Qmax=95.4%, but third cell will be 91%. The third cell is then imbalanced by 4.4%. This in turn will result in a different open circuit voltage for the third cell compared to the first and second cells, because the open circuit voltage (OCV) is in direct correlation with chemical state of charge.

While the percentage of SOC unbalance may remain constant during discharge, voltage differences between the cells may vary with state of charge. It can be that a cells total chemical capacity, QMAX, was different to start with. However, even if all cells were discharged by an equal amount from a fully charged state, their chemical state of charge will be different. Indeed, if all 3 cells are discharged by 100 mAh, but cell 3 has different total capacity (eg: 2000 mAh instead of 2200 mAh), the resulting chemical states of charge will be 95.4 and 95%. This in turn will also cause different OCVs. As can be seen, 200 mAh difference in QMAX causes only 0.4% difference in SOC.

Internal impedance differences between the cells can be expected to be approximately 15% per production batch. Impedance unbalances do not cause differences in OCV. However, they will cause differences in cell voltage during discharge. Indeed, cell voltage can be approximated as V=OCV+I·R. If current is negative (discharge), the voltage will be lower for a cell with higher R. If current is positive (charge), the voltage is higher for a cell with higher R.

### SUMMARY

Example embodiments of the present disclosure provide systems of cell imbalance detection. Briefly described, in architecture, one example embodiment of the system, among others, can be implemented as follows: a midpoint circuit connected to a plurality of battery cells, the midpoint circuit configured to output an average voltage of the cell voltages of the plurality of battery cells; and a comparator circuit connected to the midpoint circuit, the comparator circuit configured to: compare the cell voltage of at least one cell of the plurality of battery cells with the average voltage of the cell voltages of the plurality of battery cells, and output a status signal based on the comparison.

Embodiments of the present disclosure can also be viewed as providing methods of cell imbalance detection. In this regard, one embodiment of such a method, among others, can be broadly summarized by the following steps: determining an average voltage of a plurality of cells; comparing the voltage of at least one cell of the plurality of cells to the average voltage; and generating a status signal based on the comparing.

### BRIEF DESCRIPTION OF THE DRAWINGS

FIG. 1 is a circuit diagram of an example embodiment of a system of cell imbalance detection.

FIG. 2 is a signal diagram of an example embodiment of a system of cell imbalance detection.

FIG. 3 is a signal diagram of an example embodiment of a system of cell imbalance detection.

FIG. 4 is a circuit diagram of an example embodiment of the system of cell imbalance detection of FIG. 1 with more than two cells.

FIG. 5 is a flow diagram of an example embodiment of a method of cell imbalance detection.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Many portable devices use power battery packs with multiple cells. In order to get the desired power levels to run high-power equipment, the cells are stacked to produce higher voltage and less current for each individual cell. A problem with multiple cell packs is that the cells are not matched to one another when they are manufactured. In order to preserve the longevity of the cells, to keep them running as long as possible, it is preferable to keep the capacity in the cells matched to each other. To match the cells, the voltage of each individual cell may be determined and equalized across the cells. Existing solutions have typically involved some type of microprocessor which detects when any of the cell voltages get too high or too low. Digital processing may be used to determine the cell with excess charge which is discharged down to a lower voltage. Some applications implement a field effect transistor (FET) across the cell with excess charge, which bleeds down the voltage of that cell. The microprocessor might have a sophisticated analog to digital converter, which determines if the cell voltage exceeds a certain predetermined limit and then bleeds down the cell voltage.

Alternate solutions may monitor ground current of individual cells, or the device may sense the cell voltage compared to a particular threshold. If the cell exceeds a certain voltage, such as 4 volts for instance, it turns on cell balancing. In another alternate method, a microprocessor might have an ADC to detect whether the cell voltage exceeds a certain programmed limit, turns on balancing and balances it down until it's within a threshold from a standard cell voltage. One of the limitations of many of these approaches is that they only work for one specific cell and have no knowledge of any of the other cells in the pack. There's no perspective of other cells in the balancing with these solutions.

Example embodiments of the systems and methods of cell imbalance detection disclosed herein may prevent any cell of a multi-cell battery pack from exceeding over voltage conditions of the battery. In an example embodiment, automatic cell imbalance detection may be performed using two cells in series. The example embodiment determines the relative cell voltages. If a difference between the two cells of more than a certain threshold is detected, a cell balancing circuit may be activated to discharge the cell with the higher voltage. Example embodiments use no microprocessor, nor an ADC. An advantage of this approach over previous solutions is the relative knowledge of the cell voltages.

Example embodiments of systems of cell balancing are configured to work with two cells connected in series. An average voltage reading of cell 1 and cell 2 may be taken. This may be substantially equal to half of the voltage at the top of the two cells, which may be determined to be the midpoint voltage. If the cells are substantially balanced, the voltage at the top of the bottom cell should be substantially equal to the average of the two cells, or the midpoint voltage. However, if the voltage of the top cell is greater than the voltage of the bottom cell, the top cell is discharged until it is within a threshold voltage of the voltage of the bottom cell.

To detect that one cell is larger than the other, a resistor divider (R1, R2) may be used to split each of the cell voltages into two different voltages. In an example embodiment, R1 is not equal to R2. In this example embodiment, R1 may be much larger than R2. This resistor divider sets the threshold voltage which determines when the cell difference is too large and discharge should begin.

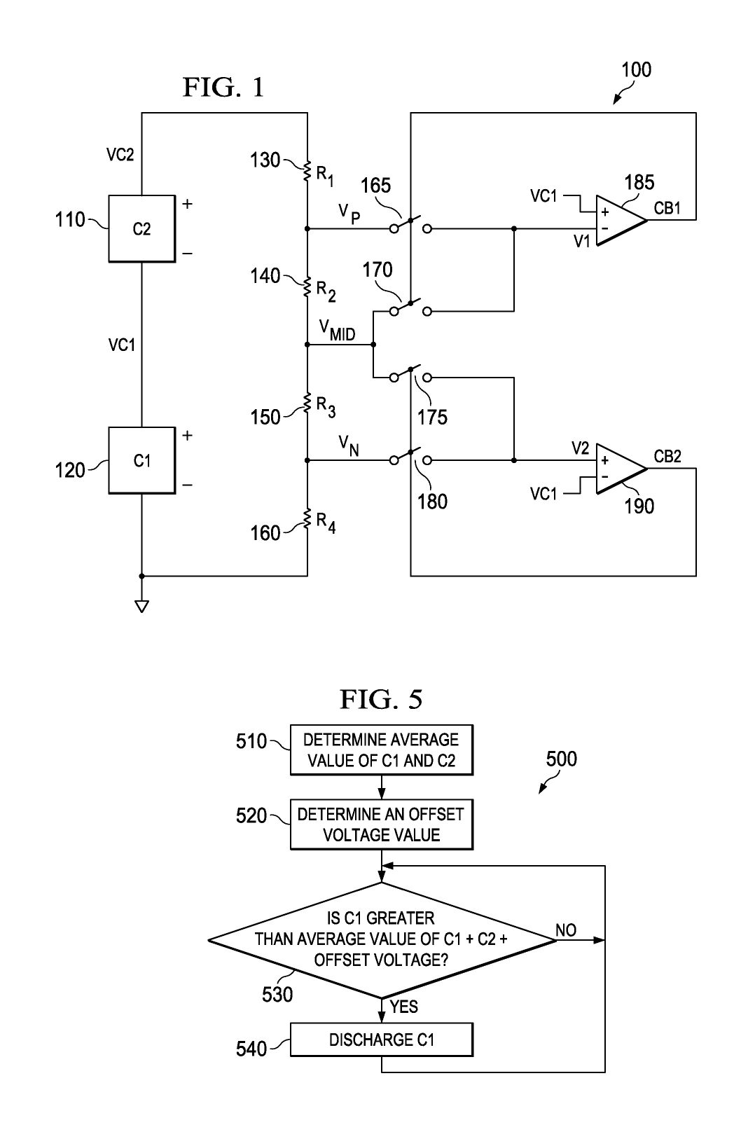

FIG. 1 provides a circuit diagram of an example embodiment of a system of cell imbalance detection. Cell 1 120 and cell 2 110 are connected in series. VC2 is the voltage of both cell 1 120 and cell 2 110. VC1 is a voltage of cell 1 120. A resistor divider of R1 130, R2 140, R3 150, and R4 160 are configured in series from VC2 to ground. In an example embodiment, R1 130 and R2 140 are not equal as R3 150 and R4 160 are not equal. R1 130, in an example embodiment, is substantially equal to R3 150 and R2 140, in an example embodiment, is substantially equal to R4 160. The resistor divider sets a mid-point between R2 140 and R3 150. The midpoint is substantially equal to VC2/2. VP, which is the voltage between R1 130 and R2 140, is equal to Vmid+a differential voltage. VN, which is between R3 150 and R4 160, is substantially equal to the mid point voltage (Vmid) minus the differential voltage, where the differential voltage is a small offset voltage determined by the resistor ratio between R1 130 and R2 140 (and R3 150 and R4 160).

In an example embodiment, two switches 165 and 170 with complimentary controls connect either VP or Vmid to node V1 at the inverting input of comparator 185. Similarly, two switches 175 and 180 with complimentary controls connect either VN or Vmid to node V2 at the non-inverting input of comparator 190. In this example embodiment, the inverting input of comparator 185 is V1 and the non-inverting input of comparator 185 is VC1 which is the voltage of cell 1 120. V2 is the non-inverting input of comparator 190 and VC1, again, is the inverting input of comparator 190. In this embodiment, CB1 is the output of comparator 185. CB1 transitions high when VC1 is greater than V1. CB2 is the output of comparator 190 and CB2 transitions high when V2 is greater than VC1.

In an example embodiment, system control is provided by and ultimately defined by nodes CB1 and CB2, which are the outputs of comparators 185 and 190 respectively. CB1 and CB2 may be used to enable and disable the cell balancing for cell 1 120 and cell 2 110, respectively. CB1 and CB2 may also be used to control switches 165, 170, 175 and 180, to determine which signals are multiplexed into V1 and V2, respectively. When the output of comparator 185 (CB1) is low, V1 is set to VP by closing switch 165 and opening switch 170. When the value of the output of comparator 185 (CB1) is high, V1 is set to V-mid by opening switch 165 and closing switch 170. When the output of comparator 190 (CB2) is low, the value of V2 is set to VN by closing switch 180 and opening switch 175. When the output of comparator 190 (CB2) is high, the value of V2 is set to V-mid by closing switch 175 and opening switch 180. In an example embodiment, VP is substantially equal to V-mid+the differential voltage. VN is substantially equal to V-mid minus the differential voltage.

The system may be self-contained with no external control logic or circuitry. With traditional lithium ion batteries, cell charge imbalances can be determined by measuring the cell voltages with respect to one another. When both cells are balanced, they will exhibit similar voltages. In a case of a two cell system shown in FIG. 1, the voltage of cell 1 120 would be equal to the voltage of cell 2 110. In this implementation, the normal system state is that both CB1 and CB2 are low or off when no cell imbalance is detected. Each comparator thus normally has inputs of VC1 and (V-mid minus V differential) for comparator 185, and inputs of (V-mid minus V differential) and VC1 for comparator 190. In an example embodiment, comparator 185 is used to detect when cell 1 120 has developed an excessive charge compared to cell 2 110 and the output will go high when VC1 is equal to V-mid+V differential. VC1 is simply equal to the voltage of cell 1 120. V-mid is equivalent to the average of cell 1 120 and cell 2 110 due to the resistor divider configuration.

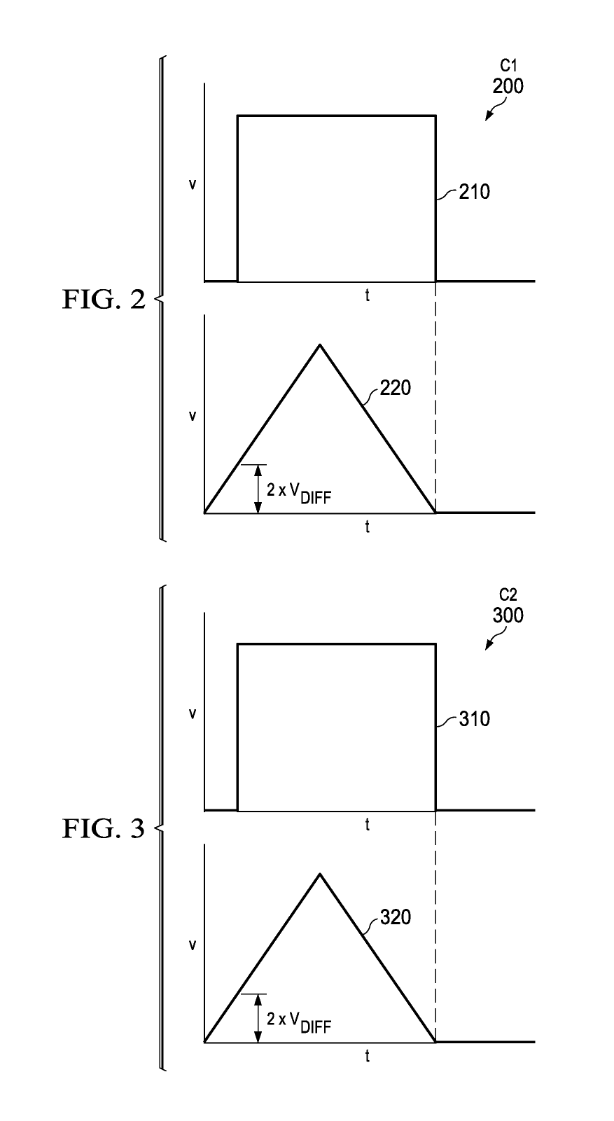

The comparator trip condition may be expressed as transitioning from low to high when cell 1 equals cell 2+2×Vdiff (the differential voltage). The differential voltage is defined by the resistor divider. The two times the differential voltage factor is due to the voltage offset between cell 1 and cell 2. It defines the threshold for enabling the cell balancing as shown in FIG. 2. Referring to FIG. 2, CB1 is provided by signal 210 and the difference between cell 1 and cell 2 is provided by signal 220. When signal 220 reaches a voltage of twice the differential voltage, CB1 210 transitions high. CB1 210 transitions low when the difference between cell 1 and cell 2 is zero. When CB1 transitions from low to high, cell 1 120 begins cell balancing. This may be accomplished with a separate block or device using a traditional architecture such as a FET across cell 1 to discharge the excess charge.

Additionally, when CB1 switches from low to high, the switch that previously connected VP to V1 is disconnected. Switch 165 opens and switch 170 between V-mid and V1 is closed. Since the inverting terminal of comparator 185 is now connected to V-mid instead of VP, CB1 will transition from high to low when cell 1 is substantially equal to cell 2. Thus, in order for comparator 185 to return to an off state or a low state, cell 1 120 must decrease until it is substantially equally to cell 2 110. When cell 1 120 is substantially equal to cell 2 110, CB1 toggles from high to low, which ceases the cell balancing of cell 1 120. CB1 opens switch 170 between V-mid and V1 and closes switch 165 between VP and V1.

Referring back to FIG. 1, comparator 190 may be used to detect when cell 2 110 has developed an excessive charge compared to cell 1 120 and will transition from low to high when VC1 is substantially equal to V-mid minus V-diff. VC1 is equal to the voltage of cell 1 120. V-mid is equal to the average of cell 1 120 and cell 2 110 due to the resistor divider. Thus, the output of comparator 190 transitions from low to high when cell 2 is equal to cell 1 plus 2 times V-diff. V1 is compared to VC1 which is the voltage of cell 2 110. To balance the cells, VC1 should be substantially equal to V-mid. Comparator 185 compares VP with VC1. If VP is lower than VC1, CB1 transitions high which indicates that the voltage of cell 1 120 is too high. When cell 1 120 is too high, it may be discharged until it is within a threshold voltage of cell 2 110. To discharge cell 1 120 in an example embodiment, CB1 drives a FET which may be configured across cell 1 120. When the FET is turned on, the FET creates an alternative path to discharge the cell.

If VC1 falls below VN, then the voltage of cell 2 110 is too high compared to the voltage of cell 1 120. When cell 2 110 is too high, the top cell is discharged until it is within a threshold level of cell 1 120. There is a hysteresis that is set by R2 140. The threshold is set by the ratio of R1 130 to R2 140. The “off” value is preferably V-mid. So, in an example embodiment, the FETs turn off when the cells are substantially balanced to V-mid. Normally VP is connected to V1 and VN is connected to V2 so the on threshold is used in comparing the relative voltages of the cells. Once either CB1 or CB2 goes high, then one of the sets of switches switches over so that V-mid is compared to VC1. In the case in which V1 is higher than VC1, CB1 transitions high, switches 165 and 170 transition, and the input to comparator 185 is no longer VP; instead, it is V-mid. Additionally, the value of CB1 does not transition back to zero until VC1 is substantially equal to V-mid.

FIG. 3 provides a signal diagram of the transition of CB2 310 due to the change in the voltage difference between cell 2 and cell 1. CB2 310 transitions from low to high when the voltage difference between cell 2 and cell 1 reaches two times the differential voltage, where the differential voltage is set by the resistor divider as provided in FIG. 1. CB2 310 transitions from high to low when the voltage of cell 2 equals the voltage of cell 1. Again, the two times the voltage differential value is the voltage offset between cell 1 and cell 2 which defines the threshold for enabling cell balancing. When the comparator trip condition is reached, CB2 310 toggles from low to high. When CB2 transitions from low to high, cell 2 110 begins cell balancing. This may be accomplished with a separate block using a traditional architecture such as a FET configured across cell 2 to discharge cell 2. Additionally, when CB2 transitions from low to high, switch 180 between VN and V2 is open and switch 175 between V-mid and V2 is closed. In this example embodiment, the non-inverting terminal of comparator 190 is now connected to V-mid instead of VN. The output of comparator 190 transitions from high to low when cell 1 equals cell2. Thus, in order for the comparator to return to an off state or a low state, cell 1 120 must decrease until it is substantially equal to cell 2 110. When cell 1 120 is substantially equal to cell 2 110, CB2 transitions from high to low, which terminates the cell balancing of cell 2 110. Additionally, switch 175 connecting V-mid to V2 is opened and switch 180 between VN and V2 is closed.

The systems and methods of cell imbalance detection disclosed herein may be used on a two-cell battery pack; but it may be used for a battery pack with any number of cells. To work with a three cell pack, an additional circuit may be connected to cell 2 and cell 3. In the additional circuit, cell 1 becomes cell 2 and cell 2 becomes cell 3. Cell 2 is relative to both circuits. This may be repeated for any number of cells. In an example embodiment, there is no communication from cell 1 and cell 8, for example. In a 4 cell pack for example, one circuit balances cell 1 and cell 2, a second circuit balances cell 2 and cell 3, and a third circuit balances cell 3 and cell 4. N−1 circuits may be used to balance N cells.

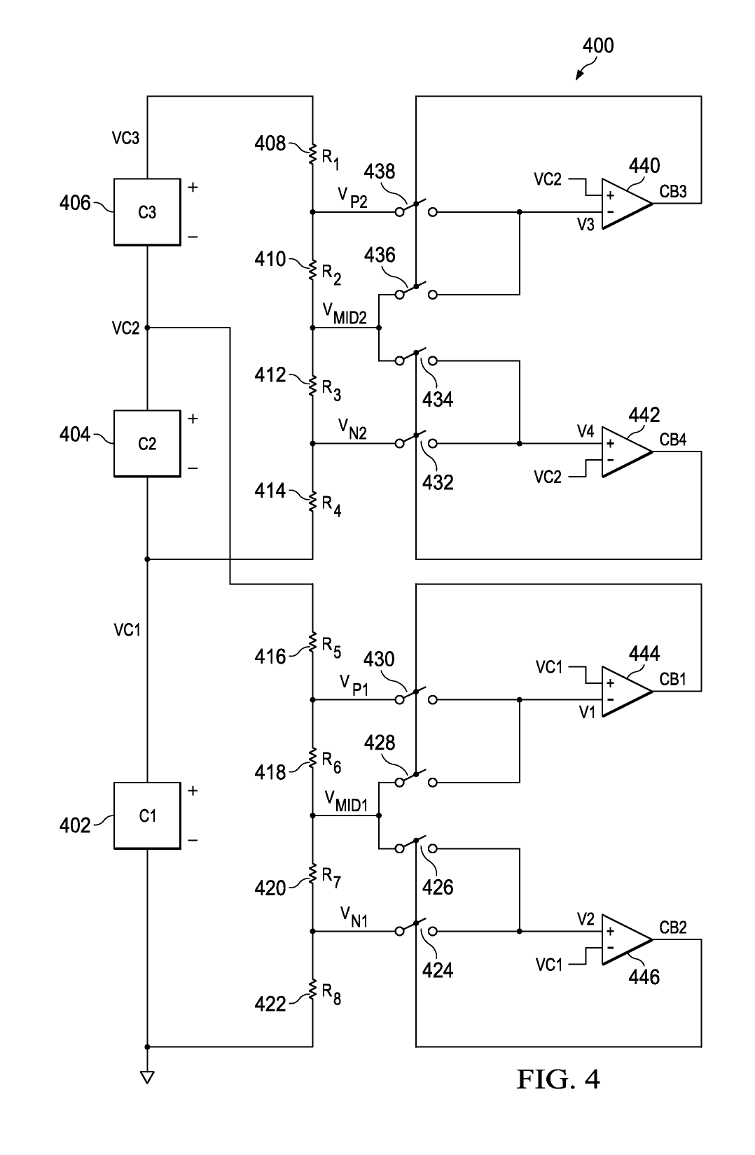

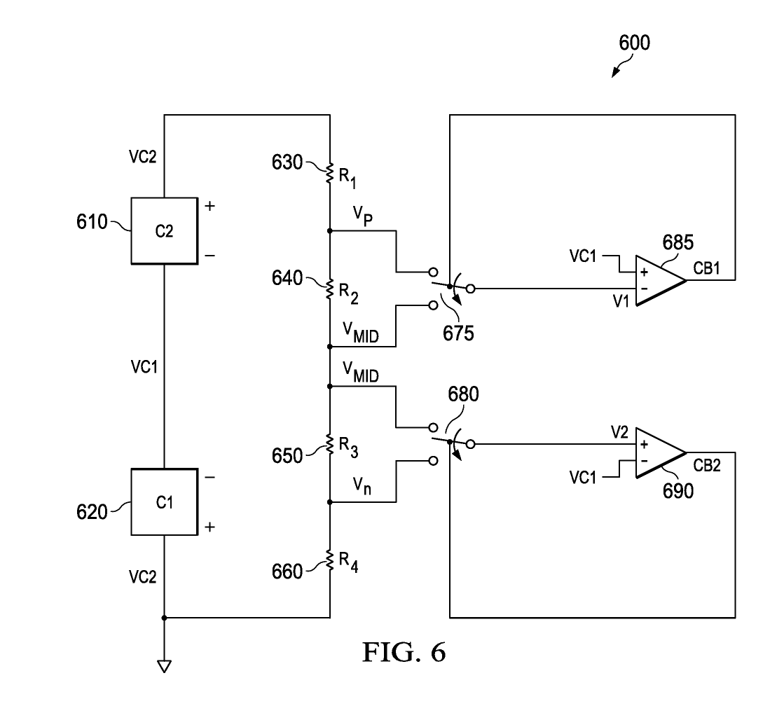

FIG. 4 provides circuit diagram 400 of an example embodiment of three cells stacked in series: cell1 402, cell2 404, and cell3 406. To balance three cells, two circuits such as those shown in FIG. 1 are used. The first circuit balances cell1 402 and cell2 404 and the second circuit balances cell2 404 and cell3 406 with the result that cell1 402, cell2 404, and cell3 406 are all balanced with each other. In the first circuit, to balance cell1 402 and cell2 404 resistors R5 416, R6 418, R7 420, and R8 422 are set from the top of cell2 404 which is VC2 to the bottom of cell1 402. Again, VC1 is equal to the cell voltage of cell1 402. V-mid 1 is equal to cell1 402+ cell2 404/2. In an example embodiment, R5 416 and R6 418 are not equal as R7 420 and R8 422 are not equal. R5 416, in an example embodiment, is substantially equal to R7 420 and R6 418, in an example embodiment, is substantially equal to R8 422. The resistor divider sets a mid-point between R6 418 and R7 420. The midpoint is substantially equal to VC2/2. VP1, which is the voltage between R5 416 and R6 418, is substantially equal to Vmid1+a differential voltage. VN1, which is between R7 420 and R8 422, is substantially equal to the mid point voltage (Vmid1) minus the differential voltage, where the differential voltage is a small offset voltage determined by the resistor ratio between R5 416 and R6 418 (and R7 420 and R8 422).

In an example embodiment, two switches 430 and 428 with complimentary controls connect either VP1 or Vmid1 to node V1 at the inverting input of comparator 444. Similarly, two switches 426 and 424 with complimentary controls connect either VN1 or Vmid1 to node V2 at the non-inverting input of comparator 446. In this example embodiment, the inverting input of comparator 444 is V1 and the non-inverting input of comparator 444 is VC1 which is the voltage of cell 1 402. V2 is the non-inverting input of comparator 446 and VC1, again, is the inverting input of comparator 446. In this embodiment, CB1 is the output of comparator 444. CB1 transitions high when VC1 is greater than V1. CB2 is the output of comparator 446 and CB2 transitions high when V2 is greater than VC1.

In an example embodiment, control of the circuit for cell1 402 and cell2 404 is provided by and ultimately defined by nodes CB1 and CB2, which are the outputs of comparators 444 and 446 respectively. CB1 and CB2 may be used to enable and disable the cell balancing for cell 1 402 and cell 2 404, respectively. CB1 and CB2 may also be used to control switches 430, 428, 426 and 424, to determine which signals are multiplexed into V1 and V2, respectively. When the output of comparator 444 (CB1) is low, V1 is set to VP1 by closing switch 430 and opening switch 428. When the value of the output of comparator 444 (CB1) is high, V1 is set to V-mid1 by opening switch 430 and closing switch 428. When the output of comparator 446 (CB2) is low, the value of V2 is set to VN1 by closing switch 424 and opening switch 426. When the output of comparator 446 (CB2) is high, the value of V2 is set to V-mid1 by closing switch 426 and opening switch 424. In an example embodiment, VP1 is substantially equal to V-mid1+the differential voltage. VN1 is substantially equal to V-mid1 minus the differential voltage.

The second circuit balances cell2 404 and cell3 406. To balance cell2 404 and cell3 406, resistors R1 408, R2 410, R3 412, and R4 414 are set from the top of cell3 406 which is VC3 to the bottom of cell2 404. VC2 is equal to the cell voltage of cell2 404. V-mid1 is equal to cell2 404+cell3 406/2. In an example embodiment, R1 408 and R2 410 are not equal as R3 412 and R4 414 are not equal. R1 408, in an example embodiment, is substantially equal to R3 412 and R2 410, in an example embodiment, is substantially equal to R4 414. The resistor divider sets a mid-point between R2 410 and R3 412. The midpoint is substantially equal to VC3/2. VP2, which is the voltage between R1 408 and R2 410, is substantially equal to Vmid2+a differential voltage. VN2, which is between R3 412 and R4 414, is substantially equal to the mid point voltage (Vmid2) minus the differential voltage, where the differential voltage is a small offset voltage determined by the resistor ratio between R1 408 and R2 410 (and R3 412 and R4 414).

In an example embodiment, two switches 438 and 436 with complimentary controls connect either VP2 or Vmid2 to node V3 at the inverting input of comparator 440. Similarly, two switches 434 and 432 with complimentary controls connect either VN2 or Vmid2 to node V4 at the non-inverting input of comparator 442. In this example embodiment, the inverting input of comparator 440 is V3 and the non-inverting input of comparator 440 is VC2 which is the voltage of cell 2 404. V4 is the non-inverting input of comparator 442 and VC2, again, is the inverting input of comparator 442. In this embodiment, CB3 is the output of comparator 440. CB3 transitions high when VC2 is greater than V3. CB4 is the output of comparator 442 and CB4 transitions high when V4 is greater than VC2.

In an example embodiment, control of the circuit for cell2 404 and cell3 406 is provided by and ultimately defined by nodes CB3 and CB4, which are the outputs of comparators 440 and 442 respectively. CB3 and CB4 may be used to enable and disable the cell balancing for cell 2 404 and cell 3 406, respectively. CB3 and CB4 may also be used to control switches 438, 436, 434 and 432, to determine which signals are multiplexed into V3 and V4, respectively. When the output of comparator 440 (CB3) is low, V3 is set to VP2 by closing switch 438 and opening switch 436. When the value of the output of comparator 440 (CB3) is high, V3 is set to V-mid2 by opening switch 438 and closing switch 436. When the output of comparator 442 (CB4) is low, the value of V4 is set to VN2 by closing switch 432 and opening switch 434. When the output of comparator 442 (CB4) is high, the value of V4 is set to V-mid2 by closing switch 434 and opening switch 432. In an example embodiment, VP2 is substantially equal to V-mid2+the differential voltage. VN2 is substantially equal to V-mid2 minus the differential voltage.

FIG. 5 presents flow diagram 500, a method of cell imbalance detection and auto-correction. In block 510, an average value of cell1 and cell2 is determined. In block 520, an offset voltage value is determined. In block 530, a determination is made whether cell 1 is greater than cell2+two times the offset voltage. If it is not greater, then the determination is repeated. If it is greater, then cell1 is discharged and the determination is again made. Cell1 is discharged in block 540.

FIG. 6 provides circuit 600, an alternative embodiment of the circuit of FIG. 1. In this alternative embodiment, top two switches 165, 170 in FIG. 1 are changed to one switch and the bottom two switches 175, 180 in FIG. 1 are replaced with one switch. Cell 1 620 and cell 2 610 are connected in series. VC2 is the voltage of both cell 1 620 and cell 2 610. VC1 is a voltage of cell 1 620. A resistor divider of R1 630, R2 640, R3 650, and R4 660 are configured in series from VC2 to ground. In an example embodiment, R1 630 and R2 640 are not equal as R3 650 and R4 660 are not equal. R1 630, in an example embodiment, is substantially equal to R3 650 and R2 640, in an example embodiment, is substantially equal to R4 660. The resistor divider sets a mid-point between R2 640 and R3 650. The midpoint is substantially equal to VC2/2. VP, which is the voltage between R1 630 and R2 640, is equal to Vmid+a differential voltage. VN, which is between R3 650 and R4 660, is substantially equal to the mid point voltage (Vmid) minus the differential voltage, where the differential voltage is a small offset voltage determined by the resistor ratio between R1 630 and R2 640 (and R3 650 and R4 660).

In an example embodiment, single switch 675 connects either VP or Vmid to node V1 at the inverting input of comparator 685. Similarly, switch 680 connects either VN or Vmid to node V2 at the non-inverting input of comparator 690. In this example embodiment, the inverting input of comparator 685 is V1 and the non-inverting input of comparator 685 is VC1 which is the voltage of cell 1 620. V2 is the non-inverting input of comparator 690 and VC1, again, is the inverting input of comparator 690. In this embodiment, CB1 is the output of comparator 685. CB1 transitions high when VC1 is greater than V1. CB2 is the output of comparator 690 and CB2 transitions high when V2 is greater than VC1.

In an example embodiment, system control is provided by and ultimately defined by nodes CB1 and CB2, which are the outputs of comparators 685 and 690 respectively. CB1 and CB2 may be used to enable and disable the cell balancing for cell 1 620 and cell 2 610, respectively. CB1 and CB2 may also be used to control switches 675 and 680 to determine which signals are multiplexed into V1 and V2, respectively. When the output of comparator 685 (CB1) is low, V1 is set to VP with switch 675. When the value of the output of comparator 685 (CB1) is high, V1 is set to V-mid with switch 675. When the output of comparator 690 (CB2) is low, the value of V2 is set to VN with switch 680. When the output of comparator 690 (CB2) is high, the value of V2 is set to V-mid with switch 680. In an example embodiment, VP is substantially equal to V-mid+the differential voltage. VN is substantially equal to V-mid minus the differential voltage.

Although the present invention has been described in detail, it should be understood that various changes, substitutions and alterations can be made thereto without departing from the spirit and scope of the invention as defined by the appended claims.

Therefore, at least the following is claimed:

1. A system comprising:
a midpoint circuit connected to a plurality of battery cells, the midpoint circuit configured to output an average voltage of the cell voltages of the plurality of battery cells; and
a comparator circuit connected to the midpoint circuit, the comparator circuit configured to:
compare the cell voltage of at least one cell of the plurality of battery cells with the average voltage of the cell voltages of the plurality of battery cells, and
output a status signal based on the comparison.

2. The system of claim 1, further comprising a discharge circuit connected to the output of the comparator circuit, the discharge circuit configured to discharge at least one of the plurality of cells that has a voltage that exceeds the average voltage.

3. The system of claim 1, wherein the comparator circuit comprises at least one comparator configured to compare the voltage of one cell of the plurality of cells with the average voltage.

4. The system of claim 3, wherein the voltage of one cell and the average voltage are analog representations of the voltage.

5. The system of claim 1, further comprising a resistor divider configured to set the average voltage of the plurality of cells.

6. The system of claim 5, wherein the resistor divider is further configured to set an offset voltage, the offset voltage used to enable a discharge circuit.

7. The system of claim 6, wherein the discharge circuit is enabled when the voltage of the cell is greater than the sum of the average voltage and the offset voltage.

8. A method comprising:
determining an average voltage of a plurality of cells;
comparing the voltage of at least one cell of the plurality of cells to the average voltage; and
generating a status signal based on the comparing.

9. The method of claim 8, further comprising discharging the at least one cell of the plurality of cells when the voltage of the at least one cell is greater than the average voltage.

10. The method of claim 8, wherein the determining step is performed by dividing the voltage of the plurality of cells with a voltage divider.

11. The method of claim 8, further comprising setting an offset voltage to enable a discharge circuit.

12. The method of claim 11, further comprising enabling the discharge circuit when the voltage of the cell is greater than the sum of the average voltage and the offset voltage.

13. A system of balancing cells in a battery pack, comprising:
a first voltage divider configured to determine a first average voltage of a first and a second cell of the battery pack;
a first comparator circuit configured to compare the first cell voltage with the first average voltage and to compare the second cell voltage with the first average voltage and to output a first status signal if either the first cell voltage or the second cell voltage is greater than the first average voltage;
a second voltage divider configured to determine a second average voltage of the second cell and a third cell of the battery pack; and
a second comparator circuit configured to compare the second cell voltage with the second average voltage and to compare the third cell voltage with the second average voltage and to output a second status signal if either the second cell voltage or the third cell voltage is greater than the second average voltage.

14. The system of claim 13,
wherein the first voltage divider comprises a first resistor, a second resistor, a third resistor, and a fourth resistor; and
wherein the first resistor is large relative to the second resistor, the third resistor is large relative to the fourth resistor, the sum of the first resistor and the second resistor Is substantially equal to the sum of the third resistor and the fourth resistor, and the second resistor is substantially equal to the fourth resistor.

15. The system of claim 14, wherein the second resistor and the fourth resistors determine an offset voltage and the first comparator circuit outputs a first status signal if the first cell is greater than the sum of the first average voltage and the offset voltage.

16. The system of claim 15, further comprising a switching circuit, configured to switch the input of the first comparator circuit between the first average voltage and the sum of the first average voltage and the offset voltage.

17. The system of claim 13,
wherein the second voltage divider comprises a fifth resistor, a sixth resistor, a seventh resistor, and an eighth resistor; and
wherein the fifth resistor is large relative to the sixth resistor, the seventh resistor is large relative to the eighth resistor, the sum of the fifth resistor and the sixth resistor Is substantially equal to the sum of the seventh resistor and the eighth resistor, and the sixth resistor is substantially equal to the eighth resistor.

18. The system of claim 17, wherein the sixth resistor and the eighth resistors determine a second offset voltage and the second comparator circuit outputs a second status signal if the second cell is greater than the sum of the second average voltage and the second offset voltage.

19. The system of claim 13, a first discharge circuit configured to discharge the first cell if the voltage of the first cell is greater than the first average voltage.

20. The system of claim 13, a second discharge circuit configured to discharge the second cell if the voltage of the second cell is greater than the second average voltage.
